(19) United States
(12) Patent Application Publication
(10) Pub. No.: US 2007/0148076 A1
(43) Pub. Date: Jun. 28, 2007

(54) Method for producing a reversible hydrogen storage medium with high storage capacity and ultrafast kinetics

(76) Inventors: Yun Hang Hu, Williamsville, NY (US); Eli Ruckenstein, Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/654,974

(22) Filed: Jan. 18, 2007

Related U.S. Application Data
(63) Continuation-in-part of application No. 11/057,437, filed on Feb. 14, 2005.
(60) Provisional application No. 60/759,921, filed on Jan. 18, 2006.

(51) Int. Cl. C01B 21/00

(52) U.S. Cl. 423/413

(57) ABSTRACT

A method is provided for the preparation of a hydrogen storage medium having a high hydrogen storage capacity, high reversibility and fast reaction time. A high storage capacity Li₂NH -containing media with high reversibility is also provided. The method comprises an ultra-fast solid reaction between Li₃N and LiNH₂ to provide an effective Li₂NH material, which can reversibly store 6.8 wt % hydrogen with fast kinetics and excellent stability.

This application claims priority to U.S. provisional application No. 60/759,921 filed on Jan. 18, 2006 and is a continuation-in-part of application Ser. No. 11/057,437, filed Feb. 14, 2005, now pending, the disclosures of which are incorporated herein by reference.

### BACKGROUND OF THE INVENTION

A low-cost hydrogen storage technology that provides a high storage capacity and fast kinetics is a critical factor in the development of a hydrogen economy for transportation. The solid-state storage is now considered as the safest and most effective way of routinely handling hydrogen [1,2] and the attention is focused on metal hydrides [3], complex hydrides [4-7], nano-tubes and fibers [8-16], micro-porous metal-organic materials [17], and lithium nitride [18-21]. A hydrogen storage technology which can economically carry enough hydrogen on-board of a vehicle to enable a 300-mile vehicle range is critical to make the hydrogen-powered automobiles competitive with the traditional vehicles. Furthermore, the DOE mid-term target for on-board hydrogen storage material is 6 wt % reversible hydrogen capacity with fast kinetics. At the present time, no existing hydrogen storage material meets this target.

As early as 1910, Dafert and Miklauz reported that Li₃N can absorb 10.4 wt % hydrogen to form Li₃NH₄ [22] (Li₃N+2H₂=Li₃NH₄) and the Li₃NH₄ can decompose to release hydrogen. Furthermore, Ruff and Goeres reported that Li₃NH₄ is a mixture of LiNH₂ and 2LiH [23]. Therefore, Li₃N can be a useful storage material. However, it did not attract attention for about a century probably because of the suspicion that it can generate NH3, which, indeed, is a thermodynamically favorable process at temperatures below 400° C. [18a]. However, recent experiments showed that no NH₃ could be detected during the hydrogenation of Li₃N and the dehydrogenation of hydrogenated Li₃N [18, 21]. Furthermore, recent experiments demonstrated that an ultra-fast reaction between NH3 and LiH enables LiH to capture the entire NH3 generated during hydrogenation and dehydrogenation [18a,19]. Thus, Li₃N has recently started to attract attention as a material for hydrogen storage [18-21]. However, a critical issue is that its reversible hydrogen capacity is less than 5.5 wt %. This occurs because LiNH₂ and 2LiH, which are the products of Li₃N hydrogenation, dehydrogenate in two steps: LiH+LiNH₂=Li₂NH+H₂ and LiH+Li₂NH=Li₃N+H₂. The first step, which provides about 5.5wt % hydrogen capacity, takes place easily even at temperatures below 200° C., whereas the second step requires high temperatures (>400° C.). Furthermore, it has been found that Li₃N undergoes the binding of hydrogen at such a rate that the heat released in the binding reaction causes hot spots in the solid, resulting in sintering of the solid and a corresponding decrease in its hydrogen capacity, reversibility, and thus its usefulness as a storage medium. A stable hydrogen storage medium which has a high storage capacity and a high reversibility would be a significant advance in the storage of hydrogen, particularly for use in portable hydrogen fuel cells.

Although Li₃N can theoretically absorb as much as about 10 wt % hydrogen, its reversible hydrogen capacity is only about 5.5 wt % because only a fraction of the hydrogen absorbed can be desorbed at relatively low temperatures [24-26]. For this reason, lithium imide (Li₂NH) was considered as the most promising hydrogen storage material, because, in principle, it can reversibly absorb 6.85 wt% hydrogen [24]. Although its operation temperature for hydrogen storage is higher than the US DOE target, it was found that the doping with Mg or Ca of Li₂NH can reduce the dehydrogenation temperature of hydrogenated Li₂NH [24b,26,28]. So far, however, no commercial Li₂NH is available. In laboratories, Li₂NH was prepared via the direct thermal decomposition of LiNH₂ by heating at a temperature of 350° C. (or higher) for overnight [24,29]. However, this approach requires high energy input because the reaction is endothermic, and in addition releases ammonia, which opens environmental issues. Therefore, it is necessary to find an effective approach to prepare Li₂NH.

### SUMMARY OF THE INVENTION

The present invention provides a method for producing Li₂NH, which can reversibly store at least 4.5 wt % hydrogen. The method comprises reacting Li₃N and LiNH₂ to synthesize the Li₂NH material. In one embodiment, the method yields a solid which has a highly reversible hydrogen capacity of up to 6.8 wt %. In one embodiment, the material of the present invention can be prepared in about 10 minutes. In contrast, Li₂NH prepared via the conventional LiNH₂ decomposition method absorbs less than 2 wt % hydrogen in 500 min, and based on scanning electron microscopy (SEM) and BET measurements, appears to be prone to sintering. Further, the hydrogen capacity of Li₂NH, prepared via the conventionally used alternative reaction between LiH and LiNH₂, reached a value of only 4 wt % after 500 min. Thus the present invention provides for Li₂NH materials that have greater hydrogen storage capacities than currently available materials.

In one embodiment, when performing the method of the invention, if LiNH₂ is added to the solid prior to the hydrogenation step, the resulting solid has an unexpectedly high reversible hydrogen capacity. In one embodiment, the resulting solid has a reversible hydrogen capacity of 6.8 wt%.

In another embodiment, we report a fast and effective synthesis approach, in which Li₂NH can be generated only in 10 min at 210° C. via the exothermic solid reaction between Li₃N and LiNH₂ without any byproduct

### BRIEF DESCRIPTION OF THE DRAWINGS

FIG. 1 The hydrogen absorption in Li-N-O. Conditions: initial pressure 7 atm and final pressure 4 atm, Li₃N=0.25 g.

FIG. 2 The stability of Li-N-O for H₂ absorption at 198° C. Conditions: initial pressure 7 atm and final pressure 4 atm, Li₃N=0.25 g.

FIG. 3 Hydrogen absorption versus reaction time at 198° C. and 7 atm (initial pressure): (a)the first absorption by fresh Li₃N without any treatment; (b)the second absorption after desorption; (c)hydrogen absorption of Li₃N treated by hydrogenation-dehydrogenation at 230° C.; (d) hydrogen absorption by the Li₃N partially oxidized by its exposure to air for 30 min, followed by heating to 200° C. in vacuum.

FIG. 4. Hydrogen absorption by Li₃N which is oxidized in wet-air for more than 2 hours, followed by decomposition and prehydrogenation-dehydrogenation treatment. Conditions: initial pressure is 7 atm, temperature is 250° C.

FIG. 5. Volumetric measurement unit (1. H₂ cylinder; 2. regulator; 3. cut-off valve; 4. reservoir container; 5. digital pressure gauge; 6. cut-off valve; 7. sample; 8. furnace; 9. reactor; 10. cut-off valve; 11. diffusion pump; 12. mechanical pump).

FIG. 6. Blank experiment for hydrogen storage when 0.25 g quartz wool at 230° C. and 7 atm (initial hydrogen pressure) was employed.

FIG. 7. Effect of composition on reversible hydrogen capacity at 230° C. and 7 atm of initial hydrogen pressure (the samples were subjected to a hydrogenation-dehydrogenation pretreatment before the determination of the reversible hydrogen capacity). The horizontal axis is in mol % of added LiNH₂ relative to the weight of the solid (LiNH₂ +Li₃N).

FIG. 8. Comparison between various samples for hydrogenation at 230° C. and 7 atm (initial hydrogen pressure): (a). 28 mol % HNH₂/Li₃N previously subjected to a hydrogenation-dehydrogenation cycle; (b).Li₃N previously subjected to a hydrogenation-dehydrogenation cycle; (c).LiH/LiNH₂ (1:1) mixture; (d).dehydrogenated LiNH₂ in vacuum at 280° C. for 12 h.

FIG. 9. Effect of cycles on reversible hydrogen capacity in a LiNH₂/Li₃N solid ( 28 mol % added LiNH₂) at 230° C. and 7 atm of initial hydrogen pressure.

FIG. 10. Rehydrogenation of a LiNH₂/Li₃N solid (28 mol % added LiNH₂) at 230° C. and 7 atm of initial hydrogen pressure (after 0.5, 1, 3, and 12 h dehydrogenation of hydrogenated LiNH₂-Li₃N, at 230° C., respectively).

FIG. 11 depicts XRD-patterns of a stoichiometric mixture of Li₃N/LiNH₂(1: 1): (a) without any treatment; (b) heated in vacuum at 150° C. for 1 h, (c)heated in vacuum at 190° C. for 1 h, (d)heated in vacuum at 210° C. for 1 h, (e)heated in vacuum at 230° C. for 1 h, (f)heated in vacuum at 210° C. for 10 min, (g)heated in vacuum at 230° C. for 10 min. (Note: Li₂O and LiOH were formed because the sample was exposed to air).

FIG. 12 illustrates hydrogen absorption by a Li₂NH (prepared via the ultra fast reaction between Li₃N and LiNH₂) at 230° C. and 7 atm initial hydrogen pressure. Before each re-absorption, the hydrogenated Li₂NH was subjected to dehydrogenation at 230° C. for 14 hours.

FIG. 13 illustrates hydrogen re-absorption at 230° C. and 7 atm initial hydrogen pressure by α Li₂NH prepared via the fast reaction between Li₃N and LiNH₂: (a).First re-absorption after the desorption of hydrogenated Li₂NH at 230° C., (b). First re-absorption after desorption of hydrogenated Li₂NH at 230° C. for 14 hours and at 350° C. for 3 hours, (c). First re-absorption after the desorption of hydrogenated Li₂NH at 230° C. for 14 hours and at 450° C. for 3 hours.

FIG. 14 illustrates hydrogen re-absorption at 230° C. and 7atm initial hydrogen pressure by a Li₂NH (a).Hydrogen re-absorption after a Li₂NH was subjected to multiple absorption-desorption cycles at 230° C. until hydrogen absorption did not change with the cycle number; (b).Cycl-1: Hydrogen re-absorption after a Li₂NH was subjected to vacuum at 230° C. for 14 hours and at 450° C. for 3 hours; Cycl-2: Hydrogen re-absorption after the sample used in cycle-1 was subjected to vacuum at 230° C. for 14 hours; Cycl-3: Hydrogen re-absorption after the sample used in cycl-2 was subjected to vacuum at 230° C. for 14 hours; Cycl-4: Hydrogen re-absorption after the sample used in cycl-3 was subjected to vacuum at 230° C. for 14 hours.

FIG. 15 illustrates hydrogen absorption at 230° C. and 7atm initial hydrogen pressure by β Li₂NH (a).Li₂NH prepared via the conventional decomposition of LiNH2 in vacuum at 230° C. for overnight; (b).Li₂NH prepared via the conventional decomposition of LiNH₂ in vacuum at 280° C. for overnight; and (c).Li₂NH prepared via the conventional decomposition of LiNH₂ in vacuum at 350° C. for overnight.

FIG. 16 depicts a scanning electron microscopy (SEM) picture for a Li₂NH prepared via the ultra-fast reaction between Li₃N and LiNH₂.

FIG. 17 depicts a scanning electron microscopy (SEM) picture for p Li₂NH prepared via the conventional decomposition reaction from LiNH₂. FIG. 18 illustrates hydrogen absorption at 230° C. and 7 atm initial hydrogen pressure by y Li₂NH via the reaction of LiH/LiNH₂ (1:1) mixture at 280° C. for overnight.

### DETAILED DESCRIPTION OF THE INVENTION

The present invention provides a stable hydrogen storage medium with a high hydrogen storage capacity and reversibility. Also provided is a method for making such a medium. The method comprises the steps of 1) forming lithium oxide on the surface of a solid comprising Li₃N, either through an oxidation step or some other means; and 2) subjecting the solid to hydrogenation, followed by dehydrogenation. The first step is referred to as the “oxidation” step.

Without desiring to be bound by theory it is thought that the partial oxidation and prehydrogenation-dehydrogenation treatments are important for the following reason: The hydrogenation of Li₃N (Li₃N+H₂=Li₂NH+LiH, ΔH=−116 kJ/mol) is a highly exothermic reaction with fast kinetics, which leads to the generation of hot spots and sintering of the Li₃N material, reducing its suitability as a reversible hydrogen storage medium. However, when a part of the Li₃N surface is oxidized to Li₂O (for example, by being transformed into LiOH in air at room temperature and decomposed into Li₂O in vacuum at a higher temperature), Li₂O covers many of the surface active sites of Li₃N. One effect of the subsequent prehydrogenation-dehydrogenation pretreatment is the diffusion of Li₂O, initially distributed at the surfaces of the solid, into the bulk of the sample. The dispersed Li₂O also plays the role of a stabilizer. Another effect of prehydrogenation-dehydrogenation is the conversion of Li₃N into Li₂NH. The hydrogen absorption of the hydrogenation-dehydrogenation pretreated sample is provided by the reaction (Li₂NH+H₂=LiNH₂+LiH, ΔH=−45 kJ/mol), which has a much lower reaction heat (−45 kJ/mol) than the hydrogenation of Li₃N (−116 kJ/mol). The combination of the lower reaction heat and the dispersion of Li₂O prevents the pretreated material from sintering during the hydrogen absorption.

The Li₃N solid of the present invention can be prepared and used in a range of solid forms such as powdered, granular, monolith, etc. However, powdered, granular and other particulate forms are preferred as they have a high ratio of surface area to volume. Preferred are particulate forms which include particle sizes with diameters in the range of from 0.5 nm to 10 mm. In one embodiment, the particulate forms include particles with sizes in the range of from 10 μm to 1 mm.

If a particulate form is desired, the Li₃N solid of the present invention can be prepared by grinding with a mortar and pestle, or by other processes which produce particulate Li₃N.

The Li₃N is subjected to conditions such that Li₂O forms in or on the surface layer of the solid. If particulate Li₃N is desired, partial or full oxidation can be performed during the particulating process. An example is the formation of particles by grinding, in the presence of air which contains H₂O. In one embodiment, such a process results in the surface formation of LiOH. The LiOH can be further decomposed to into Li₂O in a subsequent step, such as subjecting the ground solid to a vacuum in the range of from 1×10⁻⁶ to 1 Pa, at temperatures in the range of from 50° C. to 400° C. In one embodiment, the vacuum is in the range of from 1×10⁻⁵ to 1×10⁻³ Pa, and the temperature is in the range of from 100° C. to 300° C. In general, the Li₂O is present in the surface layer in a distribution which is similar to the distribution of the LiOH which is decomposed to obtain the Li₂O. It is preferred that the Li₂O be present in an amount between 0.1 and 20 wt % of the solid.

The Li₂O -bearing solid Li₃N is then subjected to a prehydrogenation step in which it is hydrogenated at least partially to capacity. By “partially to capacity,” it is meant that the solid has the ability to bind additional hydrogen. The term “prehydrogenation” as used herein refers to the first hydrogenation following the oxidation step. Preferably, the prehydrogenation is conducted at a hydrogen pressure or partial pressure in the range of from 0.1 atm to 100 atm, a temperature in the range of from 50° C. to 400° C. for a time in the range of from 0.5 to 48 hours. In a preferred embodiment, the solid is prehydrogenated at a hydrogen pressure or partial pressure in the range of from 5 atm to 20 atm, a temperature in the range of from 100° C. to 300° C., for a time in the range of from 10 to 24 hours and is prehydrogenated to capacity. In general, the hydrogen capacity of the solid formed by the method of the present invention is highest if the solid is prehydrogenated to capacity. The solid is preferably prehydrogenated to at least 50% of its hydrogen capacity, and more preferably prehydrogenated to at least 80% of its hydrogen capacity. In one embodiment, the solid is hydrogenated to 100% of its hydrogen capacity.

The solid is then at least partially dehydrogenated. Preferably, the solid is dehydrogenated at a pressure in the range of from 1×10⁻⁶ to 1×10⁵ Pa, a temperature in the range of from 5° C. to 400° C., and a time in the range of from 0.5 to 48 hours. In one embodiment, the solid is dehydrogenated at a pressure in the range of from 1×10⁻² to 1×10³ Pa, a temperature in the range of from 100° C. to 300° C., and a time in the range of from 10 to 24 hours. By dehydrogenating “at least partially,” it is meant that after dehydrogenating, the medium still contains hydrogen which can be removed through further dehydrogenation.

It should be noted that oxidizing the solid surface such that it is completely occluded by Li₂O can compromise the ability to carry out the prehydrogenation step. It is thus preferred that the Li₂O cover at most 90% of the surface area of the solid.

The addition of LiNH₂ in the solid prior to oxidation (“preaddition” of LiNH₂) has been found to increase the hydrogen capacity of the solid relative to Li₃N solids which do not contain pre-added LiNH₂. The effect is not lost with successive hydrogenation/dehydrogenation steps. Without desiring to be bound by theory, the addition of LiNH₂ to the solid prior to hydrogenation is thought to act as follows. The mole ratio of LiNH₂/LiH of hydrogenated Li₃N which is free of pre-added LiNH₂ is around 0.5, and consequently only about half of the LiH in the sample can release hydrogen via the first of the dehydrogenation steps elucidated in the Background section, above (LiH+LiNH₂=Li₂NH+H₂) at sufficiently low temperatures. In contrast, through the addition of LiNH₂ to Li₃N prior to hydrogenation, the LiNH₂/LiH ratio is raised such that all or nearly all of the LiH generated by the hydrogenation of Li₃N can release hydrogen via the first step. The percentage of reversibly bound hydrogen (at sufficiently low temperatures) is thus increased. Based on such a material design idea, various LiNH₂/Li₃N mixture materials have been identified, which can provide a reversible hydrogen capacity of 6.8 wt % or even higher.

It is preferable that pre-added LiNH₂ comprise at most 90 mol % of the solid. However, when LiNH₂ is used in proportions which are less than about 55 mol %, the hydrogen capacity of the resulting solid is unexpectedly high.

For example, at 28 mol % LiNH₂, the theoretical reversible hydrogen capacity is 6.3 wt %, whereas its actual hydrogen capacity is 6.8 wt %. At 14 mol % LiNH₂, its theoretical reversible hydrogen capacity is 6 wt %, whereas its actual hydrogen capacity is 6.6 wt %. Without desiring to be bound by theory, it is thought that the higher-than-predicted reversible hydrogen capacity implies that in addition to the hydrogen produced through the first-dehydrogenation-step (LiH+LiNH₂=Li₂NH+H₂), additional reversible hydrogen is generated through the second-hydrogenation-step (LiH+Li₂NH=Li₃N+H₂).

The LiNH₂ can be conveniently incorporated into the solid by combining powdered Li₃N and LiNH₂ prior to the oxidation step. However, if desired, the powders may be combined after or during surface oxidation of the Li₃N powder.

The solid prepared by the method of the present invention has been found to maintain stability, hydrogen capacity and reversible storage capability at temperatures as high as 400° C. At higher temperatures, the medium can become chemically unstable, and the hydrogen capacity and storage reversibility may be reduced. It should also be noted that with decreasing temperature, the release of hydrogen from the medium generally decreases in thermodynamic favorability. As a result, at room temperature, medium which contains hydrogen can retain it for times on the order of years.

A conventional method for measuring hydrogen capacity of a solid is thermogravimetry, which determines the hydrogen capacity of a sample via weight change. The sample is usually kept in a H₂ flow for a certain time to determine the weight change. However, with thermogravimetry, even a H₂O impurity concentration as low as several ppm can lead to a significant error because the weight of a H₂0 molecule is equal to the weight of 9 H₂ molecules. Because of the continuous stream of H₂ employed in this method, sample can adsorb a significant amount of H₂O, particularly in small samples and during long-time measurements. For example, 0.5 wt % H₂O adsorbed can be misinterpreted as 4.5 wt % hydrogen capacity.

In contrast, the volumetric method measures the hydrogen capacity by measuring the pressure change of H₂ during absorption in a closed chamber. As a result, the adsorption of H₂O leads to less than 0.01 wt % error in the hydrogen capacity in the volumetric method.

In one embodiment, the present invention also provides a novel energy-economic synthesis approach for a Li₂NH material via a fast reaction between solids Li₃N and LiNH₂. In one embodiment, are particulate forms of Li₃N and LiNH₂ which include particle sizes with diameters in the range of from 0.5 nm to 10 mm. The reaction can be carried out at temperatures ranging from between and including 50° C. to 400° C. and preferably between and including 200° C. to 320° C. In particular embodiments, the reaction can be carried out at between and including 230° C. to 300° C. or between and including 210° C. to 230° C. At these temperatures, the reaction can be completed in times between 1 and 10 minutes, preferably between 5 and 10 minutes depending upon the temperature at which the reaction is conducted. The reaction can also be carried out for greater than 10 minutes. Those skilled in the art will recognize that at shorter times, even though the reaction has not gone to completion, appreciable Li₂NH can be formed, having hydrogen storage capacities as disclosed herein. The Li₂NH material can reversibly store at least 4.5 wt % hydrogen. In various embodiments, the Li₂NH material of the present invention can reversibly store 5.0, 5.5, 6.0, and 6.5 wt % hydrogen. In another embodiment, the Li₂NH material can reversibly store at least 6.8 wt % hydrogen. Once the hydrogen capacity of greater than 4.5 wt % is reached, the material retains its hydrogen storage capacity after at least 2 or more additional cycles of absorption and desorption. In various embodiments, the materials retains its hydrogen storage capacity after 4 and up to 7 additional cycles of absorption and desorption. The present invention provides a Li₂NH material that provides fast kinetics, i.e. hydrogen absorption and desorption. In contrast, Li₂NH prepared by the conventional LiNH₂ decomposition method absorbs less than 2 wt % hydrogen in 500 min. The poor performance of Li₂NH prepared via the conventional decomposition method can be attributed to sintering. In addition, the hydrogen capacity of Li₂NH prepared via the conventional reaction between LiH and LiNH₂, reaches only about 4 wt % after 500 minutes. Therefore, the reaction between solids Li₃N and LiNH₂ provides an unexpectedly fast and efficient method to prepare an effective Li₂NH material for hydrogen storage.

### EXAMPLE 1

The following tests demonstrate the superior hydrogen capacity, stability and reversibility of the medium provided by the present invention. Li₃N was first partially oxidized by its exposure for 30 min to air to absorb H₂O, followed by heating in vacuum to 230° C. for the decomposition of Li-H₂O to Li₂O and H₂. Then, the material was pretreated with hydrogen at 230° C. for at least 48 h and dehydrogenated at 280° C. for 24 h to ensure re-arrangements in Li₃N. The obtained material is denoted as Li-N-O.

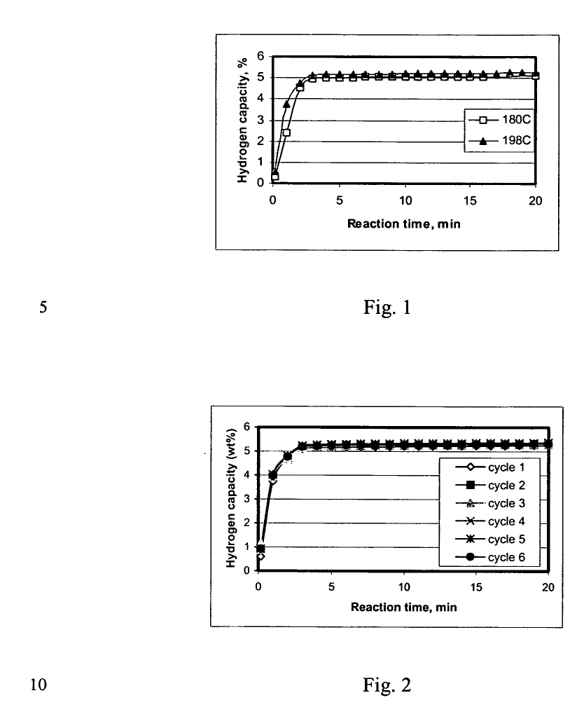

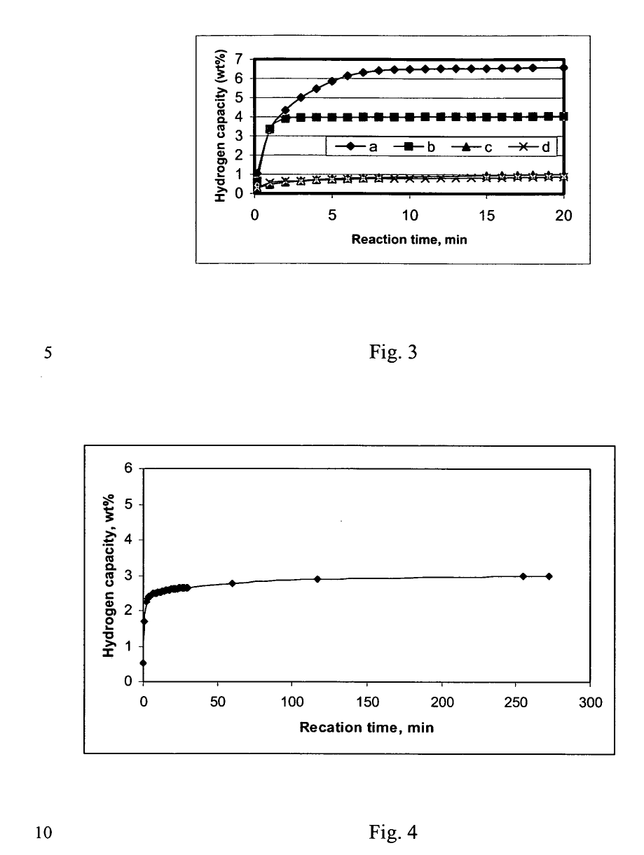

As shown in FIG. 1,the Li-N-O material could reach 5 and 5.2 wt % hydrogen capacities in only 3min at 180° C. and 198° C., respectively. Furthermore, we found that during 6 absorption-desorption cycles, the absorption curves coincided with each other at 198° C. (FIG. 2). This indicates that the Li-N-O material possesses not only an ultra-fast kinetics but also a high stability for hydrogen storage. In contrast, at the same pressure, we found that magnesium, which is the best-known metal for hydrogen storage, can hardly absorb any H₂ at temperatures below 300° C. Furthermore, as shown in FIG. 3, although the fresh pure Li₃N could absorb initially 6.5 wt % hydrogen, the hydrogen capacity dropped to 4 wt % during the second absorption after the first cycle. This indicates that the pure Li₃N has a low stability. FIG. 3 also shows that, for either the pure Li₃N pretreated by prehydrogenation-dehydrogenation or the partially oxidized Li₃N without the prehydrogenation-dehydrogenation pretreatment, the hydrogen absorption was as low as 1 wt % at 198° C. This indicates that the combination of the partial oxidation with the hydrogenation-dehydrogenation pretreatment can make Li₃N active and stable for hydrogen absorption.

### EXAMPLE 2

This example demonstrates that the reversible hydrogen capacity depends on the amount of Li₂O formed in the oxidation step. For example, in our experiments, it was found that 0.5 hours of exposure to air resulted in a suitable amount of Li₂O. However, too much oxidation caused by longer-time oxidations can give a relatively low reversible hydrogen capacity. As shown in the FIG. 4, when the exposure time in air was 2 hours, the reversible hydrogen capacity of the obtained material was only 3 wt % even at 250° C., which is much lower than that of the material with the exposure time of 0.5 h (5.2 wt %). The parameters for the experiment depicted in FIG. 4 are as follows: Li₃N was first partially oxidized by its exposure to air to absorb H₂0 for 2h, followed by heating in vacuum to 230° C. for the decomposition of Li-H₂0 to Li₂O and H₂. The material was then pretreated with hydrogen at 230° C. for at least 48 h and dehydrogenated at 280° C. for 24 h to ensure the dispersion of Li₂O.

### EXAMPLE 3

LiNH₂/Li₃N mixtures with various LiNH₂/Li₃N molar ratios were prepared by mixing powders of LiNH₂ and Li₃N (about 80 mesh) with an agate mortar and pestle, by hand, in air for 5 min. The grinding of the sample in air (at room temperature) generated a small amount of LiOH on the surface layer of the sample. This was followed by its decomposition to Li₂O on the surface layer of Li₃N by heating in vacuum at 230° C. Furthermore, the sample was subjected to an in-situ prehydrogenation (at 230° C. for 24 h), followed by dehydrogenation (at 280° C. for 12 h) before the reversible hydrogen storage measurements. For comparison purposes, Li₃N free of added LiNH₂, the mechanical mixture of LiH/LiNH₂ (1:1), and the decomposed LiNH₂, were also employed as hydrogen storage materials, and subjected to the grinding, decomposition and hydrogenation-dehydrogenation pretreatment.

### EXAMPLE 4

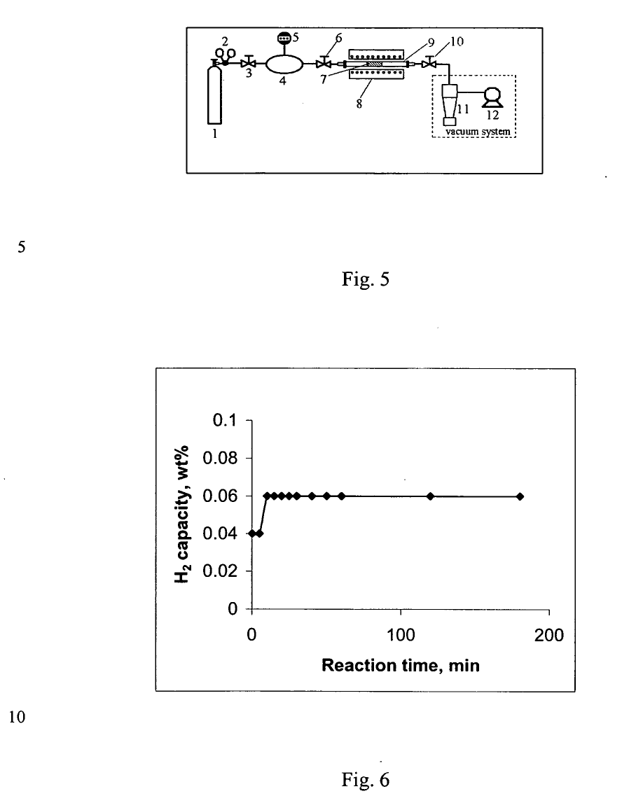

To accurately examine the hydrogen absorption by LiNH₂/Li₃N, we have employed a volumetric method (FIG. 5), which can be described as follows: A solid storage material (0.25 g) was loaded in a reactor located inside an electrical tube furnace. The reservoir 4 was filled with H₂. The pressure of H₂ in the reservoir was determined by a digital pressure gauge with two cut-off valves closed at both ends of the reservoir. The cut-off valve 6 between reservoir and reactor containing the sample was opened to allow the H₂ into the reactor, which was heated to a selected temperature. The change in the gas phase H₂ during absorption was measured using the digital pressure gauge 5. To examine the effect of the hydrogen absorption-desorption cycles, the hydrogenated sample was exposed to vacuum to desorb the hydrogen at 230° C. for 3-12 h, followed by re-absorption. An on-line mass spectrometer was used to confirm that, except hydrogen, no other compounds were present during hydrogenation and dehydrogenation. The reversible hydrogen capacity was determined as the amount of hydrogen absorbed after the sample was subjected to the hydrogenation-dehydrogenation pretreatment. The hydrogen capacity is defined as the percentage of hydrogen absorbed based on the total weight of the solid sample before any treatment.

However, in the volumetric method, one must ensure that the unit is free of leakage. Leakage test experiments showed that the pressure change in the volumetric equipment used was 0.1 psi over 10 hours, which is equivalent to 0.02 wt % hydrogen capacity for 0.25 g storage material. The equipment error was determined by running “blank” experiments in which in our blank experiments 0.25 g quartz wool, was used in the volumetric test unit rather than hydrogen storage material. Because the quartz wool can not absorb hydrogen, its measured “hydrogen capacity” is equal to the equipment error. The measured hydrogen capacity at 230° C. and 7 atm was 0.06 wt % (see FIG. 6), an error which is small relative to the hydrogen storage effects to be measured.

### EXAMPLE 5

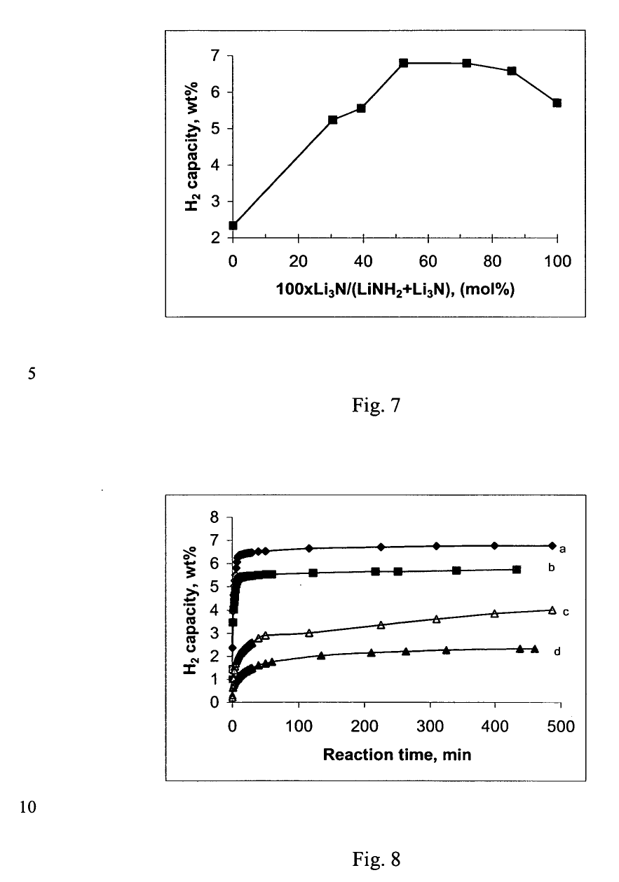

The reversibility of the hydrogen storage capacity of LiNH₂/Li₃N was determined by the volumetric method at 230° C. as described in Example 4. As shown in FIG. 7, the reversible hydrogen capacity of the solid was strongly dependent upon its composition. When the LiNH₂ was added in amounts above 50 mol % of the weight of the solid, the amount of reversible hydrogen increased with increasing Li₃N content.

When the amount of added LiNH₂ was less than 50 mol %, but larger than 28 mol %, the reversible hydrogen capacity remained almost constant at 6.8 wt %. Even for 14 mol % LiNH₂, the reversible hydrogen capacity could still reach 6.6 wt %. The reversible hydrogen capacity of Li₃N free of added LiNH₂ was 5.7 wt %. According to theoretical calculations based on the assumption that the reversible hydrogen was generated just via the first step (LiH+LiNH₂=Li₂NH+H₂), the highest reversible hydrogen capacity should be 6.85 wt %, which can be reached only when Li₃N is mixed with LiNH₂ at a mole ratio of 1:1,because at this composition, the total number of moles of LiNH₂ added plus generated during the Li₃N hydrogenation becomes equal to the number of moles of LiH generated through Li₃N hydrogenation. However, the experimental results differed from this theoretical prediction. When Li₃N was mixed with 28 mol % LiNH₂, the theoretical reversible hydrogen capacity was 6.3 wt %, whereas its real capacity was 6.8 wt %. Furthermore, when Li₃N was mixed with 14 mol% LiNH₂, its theoretical reversible hydrogen capacity was 6 wt %, whereas the real one was 6.6 wt %.

The higher reversible hydrogen capacity than predicted implies that besides the hydrogen produced through the first-dehydrogenation-step (LiH+LiNH₂=Li₂NH+H₂), additional reversible hydrogen was generated through the second-hydrogenation-step (LiH+Li₂NH=Li₃N+H₂).

As shown in FIG. 8, a 28 mol % LiNH₂/Li₃N mixture absorbed 6.0 wt % hydrogen in only 7 min at 230° C. After 40 min, the hydrogen capacity became 6.5 wt % and finally 6.8 wt %. In contrast, under the same reaction conditions, LiNH₂ free of Li₃N, which was previously subjected to dehydrogenation in vacuum at 280° C. for 12h, could just achieve 1 wt % reversible hydrogen capacity in 7 min and a final capacity of only 2.3 wt %. Furthermore, although Li₃N free of added LiNH₂ has a faster absorption rate and a higher hydrogen capacity than LiNH₂ free of Li₃N (about 2 wt % capacity) and the mechanical mixture of LiH/LiNH₂(1:1) (about 3.8 wt % capacity), its hydrogen capacity is still lower than that of the LiNH₂-added Li₃N. This indicates that the LiNH₂ with added Li₃N has both high reversible hydrogen capacity and fast absorption kinetics.

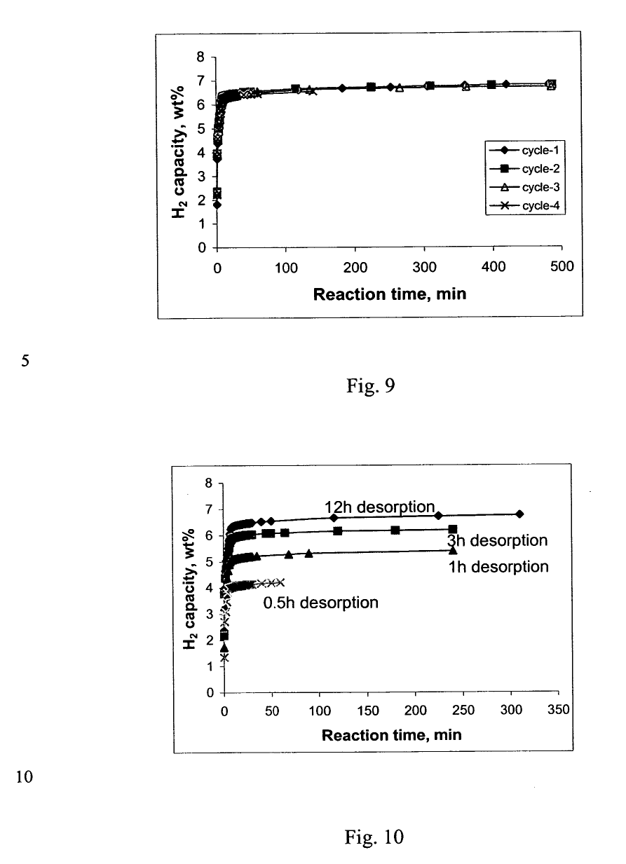

23. Usually, the low reversibility is a critical issue for most hydrogen storage materials. However, one can see from FIG. 9 that, during 4 absorption-desorption cycles, the absorption curves coincided with each other. This observation shows that LiNH₂-added Li₃N has a high stability for hydrogen storage. Furthermore, we also evaluated the dehydrogenation by determining the rehydrogenation. FIG. 10 shows that 62% of the total reversible hydrogen could desorb in only 30 min and near 80% after 60 min from the hydrogenated LiNH₂-added Li₃N. This indicates that this material has also a reasonable dehydrogenation kinetics.

### EXAMPLE 6

Here, we report a fast and effective synthesis approach, in which Li₂NH can be generated only in 10 min at 210° C. via the exothermic solid reaction between Li₃N and LiNH₂ without any byproduct.

Compared with Li₂NH, Li₃N has one more Li and one less H, whereas LiNH₂ has one more H and one less Li. Therefore, the exchange between the Li of Li₃N and the H of LiNH₂ can definitely generate Li₂NH,
Li₃N+LiNH₂=2Li₂NH (1)
Furthermore, this reaction is exothermic with ΔH=-77 kJ/mol, thus no external energy has to be provided thereby providing an energy-economic process. Starting from this simple observation, the reaction between Li₃N and LiNH₂ was studied by us using powders of LiNH₂ and Li₃N (both bought from Aldrich Chemical Company) mixed with an agate mortar and pestle by hand for 5 min. The average particle size of the powder, from scanning electron microscopy (Hitachi, S-4000), was about 10 μm. The mixture was subjected to reaction at various temperatures in vacuum, and X-ray powder diffraction patterns of the samples were determined with a Siemens D500 X-ray diffraction instrument, equipped with a Cu Kₐ source, at 40 kV and 3 OmA.

We denote Li₂NH prepared via the above approach as a Li₂NH. For comparison, we also prepared Li₂NH via LiNH₂ decomposition in vacuum at various temperatures, which is denoted as β Li₂NH. The reaction LiNH₂+LiH =Li₂NH+H₂ was also used to prepare Li₂NH (denoted as y Li₂NH): powders of LiNH₂ and LiH (both bought from Aldrich Chemical Company) were mixed with an agate mortar and pestle by hand for 5 min. The mixture was subjected to reaction at 280° C. in vacuum for overnight.

A Micromeritics ASAP 2000 instrument was used to determine, via nitrogen adsorption at 77K, the BET surface areas of various specimens. Because all samples can easily absorb H₂O from air, which can increase the surface areas during the degassing process before the BET measurements, we modified the instrument so that all treatments of the samples could be carried out in-situ. As a result, we could obtain accurate surface area values.

A scanning electron microscope (Hitachi, S-4000) was employed to examine the morphologies of the specimens after hydrogenation and dehydrogenation. The samples were coated with carbon before measurements.

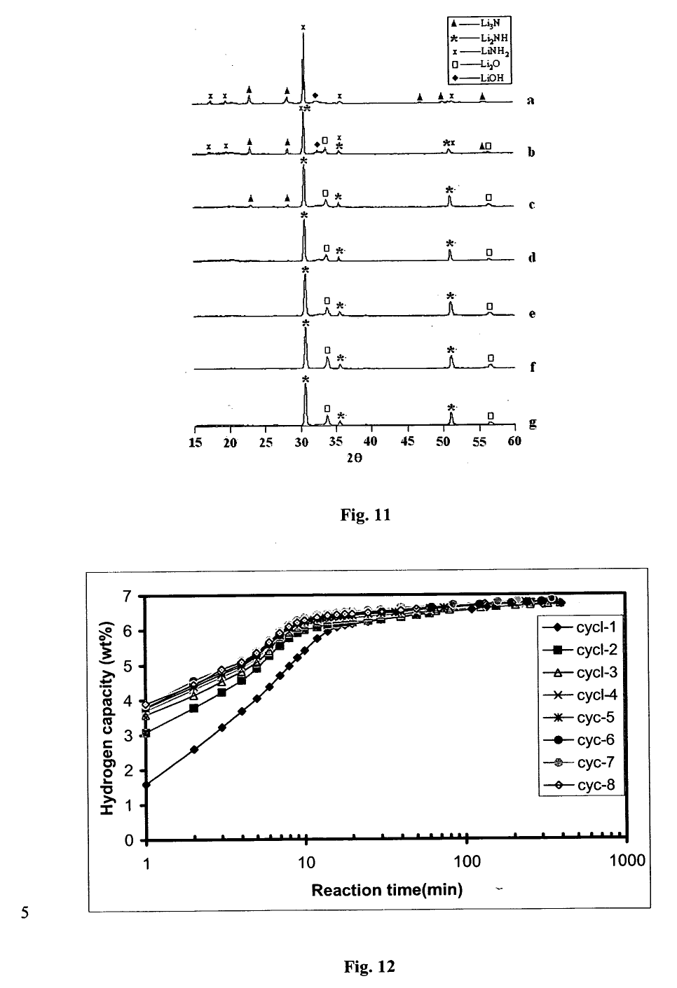

X-ray powder diffraction measurements for the stoichiometric mixture of Li₃N and LiNH₂ (1:1 mole ratio) were carried out before and after their reaction. FIG. 11a shows that before reaction the mixture contains, as expected, only Li₃N and LiNH₂. After reaction at 150° C. for 1 h, one can see from FIG. 11b that the peaks at 17.4° and 19.6°, which belong to LiNH₂, decrease, whereas the peak at about 51°, which belongs to Li₂NH, increases. The diffraction peaks of LiNH₂ and Li₂NH between 2θ=30° and 50° are very near to one another. However, the peaks at 17.4°, 19.60°, and 50° can be used to distinguish LiNH₂ from Li₂NH. The other five peaks (at 23.1, 28.4, 47.2, 50.4 and 55.9), which can be attributed to Li₃N, remain present after reaction, indicating that only part of the LiNH₂/Li₃N was transformed into Li₂NH at 150° C. in 1 h. When the reaction took place at 190° C. for 1 h, the LiNH₂ phase disappeared and the Li₃N phase decreased substantially, whereas the Li₂NH phase increased (FIG. 11c). When the reaction was carried out at 210 or 230° C. for 1 hr, LiNH₂ and Li₃N were completely transformed into Li₂NH (see FIG. 11d and 11e, respectively). Surprisingly, at 210 or 230° C., even 10 min of reaction were enough to completely transform LiNH₂ and Li₃N into Li₂NH (FIG. 11f and 11g), indicating that the reaction was very fast at 210° C. or above.

The completeness of the reaction can be measured by X-Ray diffraction. If the reaction is complete, the overall concentration of the components in the reaction system will not change. Upon substantial completion of the reaction, it is observed that one or more of the reactants disappears and that additional Li₂NH is not formed. Room temperature X-ray diffraction can be performed at 1 minute, 5 minutes, 10 minutes, 20 minutes and 1 hour after the reaction begins. In one embodiment, the Li₂NH formed is substantially free of Li₃N and LiNH₂. By substantially free, it is meant that the X-ray diffraction band corresponding to the Li₃N and LiNH₂ are not present.

This fast reaction can take place by two pathways: (a)gas intermediates and (b)direct ion exchange. The direct ion exchange is unlikely to be dominant, because the particles of 10 μm can not generate large interfaces between them. For this reason, we are inclined to believe that the fast exchange reaction between Li₃N and LiNH₂ takes place via a gas intermediate: Although Li₃N decomposition requires a very high temperature (above 813° C. [30]), LiNH₂ can partially decompose to release NH3 even at about 170° C. [24-26]. Consequently, at 210° C. or above, the NH3,released from LiNH₂, can react with Li₃N to form Li₂NH,
2LiNH₂=Li₂NH+NH₃ (2)
2Li₃N+NH₃=3Li₂NH (3)

Generally, the direct decomposition of LiNH₂ is very slow at temperatures below 350° C. [24, 25, 31, 32]. This happens because the NH3 equilibrium pressure is very low at temperatures below 350° C.^{[32]}. However, in the presence of Li₃N, the reaction is much faster, because the capturing of NH3 by Li₃N reduces the local concentration of NH₃, driving the decomposition reaction of LiNH₂ to the right (equation 2). Therefore, the reaction between Li₃N and LiNH₂ in vacuum at 210-230° C. provides a fast approach to prepare Li₂NH, which is denoted as a Li₂NH.

The hydrogen absorption by a Li₂NH was determined by using the volumetric method. A solid sample (0.25 g) was loaded in a reactor located inside an electrical tubular furnace. The change of H₂ pressure during absorption was determined using a digital pressure gauge, which could detect changes in pressure as small as 0.007 atm. The same initial H₂ pressure of 7 atm was used in all absorption experiments. An on-line mass spectrometer was used to confirm that, except hydrogen, no other compounds were present during hydrogenation and dehydrogenation. Before any reabsorption of hydrogen, the sample was subjected to vacuum (p<10⁻⁵ torr) at 230° C. It should be noted that the temperature was measured outside the reactor. Therefore, the reaction temperature does not account for the hot spots generated during reaction. The hydrogen capacity is defined as the percentage of hydrogen absorbed based on the total weight of the solid sample (Li₂NH). As shown in FIG. 12, the amount of hydrogen absorbed by the product reaches 5.4 wt % in 10 min, 6.5 wt % in 60 min, and finally about 6.8 wt %. It is well-known that Li₂NH can easily react with hydrogen at 230° C. to form LiNH₂ and LiH (Li₂NH+H₂=LiNH₂+LiH), theoretically absorbing 6.85 wt % hydrogen (based on Li₂NH weight)[24-27]. We also tested the re-absorption of hydrogen after its dehydrogenation at 230° C. for 14 h. It was found that the initial hydrogen capacity first increased with the adsorption-desorption cycle number and then remained unchanged after 4 cycles. It was also found that during seven re-absorptions the behavior was the same as during the first hydrogen absorption. This means that Li₂NH, prepared by the fast reaction between Li₃N and LiNH₂, is an excellent hydrogen storage material with high capacity and excellent stability. The conventional method to prepare Li₂NH by direct thermal decomposition of LiNH₂ requires heating at 360° C. for overnight [24,29] which is 100 times longer than that of the fast method. Furthermore, the conventional method releases NH3, which is an air-pollutant, and requires high energy-input because of its endothermic character.

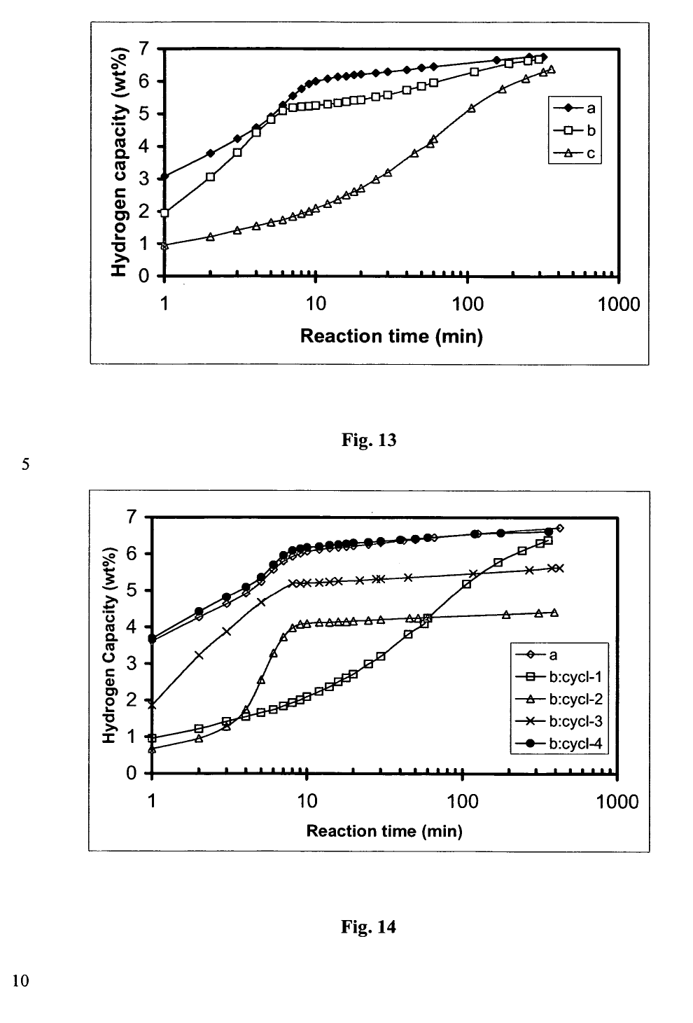

The effect of desorption temperature on hydrogen re-absorption by a Li₂NH was also examined. As shown in FIG. 13, the additional desorption at 350 or 450° C. for three hours after desorption at 230° C. decreases the initial hydrogen capacity. However, the initial hydrogen capacity can be recovered by using several desorption-absorption cycles at 230° C. (FIG. 14). Curve a in FIG. 14 represents the hydrogen re-absorption by a Li₂NH, which was previously subjected to multiple absorption-desorption cycles at 230° C. until the hydrogen absorption behavior did not change with cycle number. Curve b cycl-1 represents a much lower initial hydrogen capacity by a α Li₂NH sample, which was previously subjected to vacuum at 230° C. for 14 hours and at 450° C. for 3 hours, than that of the sample represented by curve a. However, curve b cycl-4 coincides with curve a, indicating that, after 4 cycles of adsorption-desorption at 230° C., the initial hydrogen capacity was completely recovered.

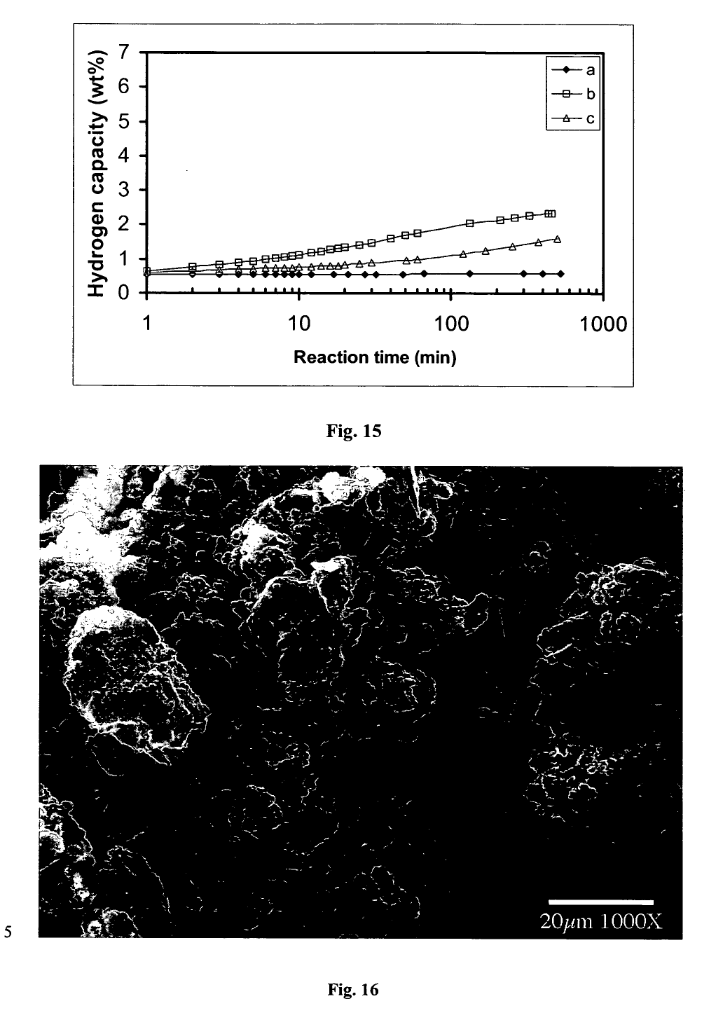

For comparison, we also examined the hydrogen absorption by Li₂NH (denoted as β Li₂NH), which was prepared by the conventional LiNH₂ decomposition method at 230, 280,and 350° C. for overnight. One can see from FIG. 15 that the reversible hydrogen capacity is less than 2 wt % with slow kinetics. This indicates that the conventional decomposition method for the preparation of Li₂NH requires not only heating at high temperatures for overnight, which is 100 times longer than that of the fast method, but also produces an ineffective Li₂NH for hydrogen storage. In addition, the conventional method releases NH3, which is an air-pollutant, and requires high energy-input because of its endothermic character.

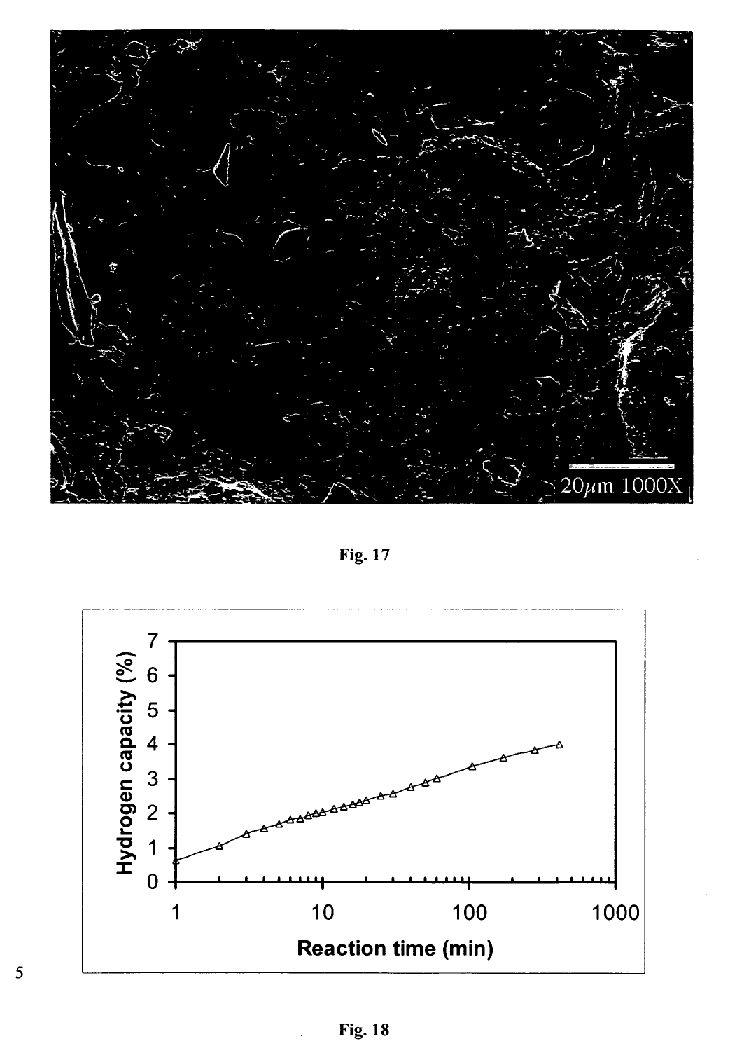

Scanning electron microscopy (SEM) was employed to examine the morphologies of the a and β Li₂NH samples prepared via the ultra-fast reaction between Li₃N and LiNH₂ as well as the conventional decomposition of LiNH₂ methods, respectively. These morphologies are presented in FIGS. 16 and 17. One can see that the α Li₂NH sample consists of particles, which were about 1 μm (FIG. 16). In contrast, the β Li₂NH sample is sintered into blocks (FIG. 17). The sintering can explain why β Li₂NH has a much lower hydrogen capacity than a Li₂NH.

TABLE 1
BET Surface Areas

| | | BET surface |
|---|---|---|
| Material | Preparation temperature and time | areas (m²/g) |
| Li₃N/LiNH₂(1/1) | No treatment | 2.5411 |
| α Li₂NH | Heating Li₃N/LiNH₂(1/1) in vacuum at | 1.9221 |
| | 280° C. for 3 h | |
| α Li₂NH | Heating Li₃N/LiNH₂(1/1) in vacuum at | 1.9576 |
| | 280° C. for 6 h | |
| α Li₂NH | Heating Li₃N/LiNH₂(1/1) in vacuum at | 1.9437 |
| | 280° C. for 9 h | |
| α Li₂NH | Heating Li₃N/LiNH₂(1/1) in vacuum at | 0.397 |
| | 350° C. for 3 h | |
| LiNH₂ | No treatment | 2.2699 |
| β Li₂NH | Heating LiNH₂ in vacuum at 280° C. | 0.2204 |
| | for 3 h. | |

Furthermore, N₂ adsorption was carried out at the temperature of liquid nitrogen (77K) on the samples. As shown in table 1, although a Li2NH has a smaller surface area than its precursor, the Li₃N/Li₂NH mixture, its surface area remained unchanged when the reaction time was increased from 3 hours to 9 hours at 280° C. This indicates that the a Li₂NH is stable at 280° C. However, when the reaction temperature was increased to 350° C., its surface area decreased from 1.9 to 0.4 m²/g. This can explain why the desorption of the hydrogenated a Li₂NH at higher temperatures led to the reduction of its re-absorption rate for hydrogen. We also measured the surface areas of β Li₂NH prepared via the conventional LiNH₂ decomposition method. Table 1 shows that its surface area is only 0.22 and 0.25 m²/g for β Li₂NH prepared at 280 and 350° C., respectively. This indicates that the material is sintered, which is consistent with the SEM measurements. Furthermore, this indicates that the surface area of α Li₂NH is about 10 times larger than that of β Li₂NH, which explains why the hydrogenation of a Li₂NH is much faster than that of β Li₂NH.

Another method to prepare Li₂NH is the reaction between LiH and LiNH₂, LiH+LiNH₂=Li₂NH+H₂. As shown in FIG. 18, this Li₂NH, denoted as y Li₂NH, prepared via this reaction at 280° C. for overnight reaches 4 wt % hydrogen capacity after 500 min of absorption time. Hence, Li₂NH prepared via the reaction between LiH and LiNH₂ has a much slower kinetics than that prepared via the ultra fast reaction between Li₃N and LiNH₂. Finally, Li₂NH can also be prepared by the reaction between NH₃ and Li or LiH followed by decomposition. As it was shown previously, the Li₂NH prepared via this reaction has also a low capacity with slow kinetics³³.

While this invention has been described through specific embodiments, routine modifications will be apparent to those skilled in the art and such modifications are intended to be within the scope of the present invention. References:
1. W. Grochala, P. P. Edwards, Chem. Rev., 2004, 104, 1283,
2. M. L. Trudeau, MRS Bulletin, 1999, 24, 23.
3. J. Genossar, and P.S. Rudman, Z f.Phys. Chem., NeueFolge 1979, 116,215.
4. R. Wiswall, in G. Alefeld and J. Völkl (eds.), Hydrogen in Metals II, Springer-Verlag, 1978, p. 201.
5. B.Bogdanovic, M. Schwickardi, J. Alloys Comp. 1997, 253, 1.
6. B. Bogdanovic and G. Sandrock, MRS Bulletin, 2002, 27, 712.
7. K.J.Gross, G.J.Thomas and C.M.Jensen, J. Alloys Comp. 2002, 330, 683.
8. A.C.Dillon, K. M. Jones, T. A. Bekkedahl, C. H. Kiang, D. S. Bethuune and M. J. Heben, Nature, 1997, 386, 377.
9. Y. Ye, C. C. Ahn, C. Witham, B. Fultz, J. Liu, A. G. Rinzler, D. Colbert, K. A. Smith, and R.E. Smalley, Appl. Phys. Lett., 1999, 74, 2307.
10. C. Liu, Y. Y. Fan, H. M. Cheng and M. S. Dresselhaus, Science 1999, 286, 1127.
11. M. Hirscher, M. Becher, M. Haluska, U. Dethlaff-Weglikowska, A. Quintel, G. S. Duesberg, Appl. Phys. A. 2001, 72, 129.
12. M. S. Dresselhaus, K. A. Williams, and P. C. Eklund, MRS Bulletin, 1999, 24, 45.
13. R. Ma, Y. Bando, H. Zhu, T. Sato, C. Xu, and D. Wu, J. Amer. Chem. Soc., 2002, 124, 7672.
14. J. Chen, N. Kuriyama, H. Yuan, H. T. Takeshita, and T. Sakai, J. Amer. Chem. Soc., 2001, 123, 11813.
15. J. Chen, S.L. Li, Z. L. Tao, Y. T. Shen, and C. X. Cui, J. Amer. Chem. Soc., 2003, 125, 5284.
16. R. T. Yang, Carbon, 2000, 38, 623.
17. N. L. Rosi, J. Eckert, M. Eddaoudi, D. T. Vodak, J. Kim, M. O'Keefe, O. M. Yaghi, Science, 2003, 300, 1127.
18. (a). Y.H. Hu, and E. Ruckenstein, J. Phys. Chem. A, 2003, 107, 9737; (b).Y. H. Hu, E. Ruckenstein, Ind. Eng. Chem. Res., 2004, 43, 2464; (c).Y.H. Hu and E. Ruckenstein, Ind. Eng. Chem. Res., 2003, 42, 5135.
19. (a). T. Ichikawa, S. Isobe, N. Hanada, H. Fujii, J. Alloys Comp., 2004, 365, 271; (b) T. Ichikawa, N. Hanada, S. Isobe, H. Y. Leng, H. Fujii, J. Phys. Chem. B. 2004, 108, 7887; (c). H. Y. Leng, T. Ichikawa, S. Hino, N. Hanada, S. Isobe, H. Fujii, J. Phys. Chem., B, 2004, 108, 8763.
20. Y. Nakamori and S. Orimo, Mater. Sci. Eng. B, 2004, 108, 48.
21. Y. H. Hu, N. Y. Yu, and E. Ruckenstein, Ind. Eng. Chem. Res. 2004, 43, 4174.
22. F. W. Dafert , and R., Miklauz, Monatsh. Chem. 1910, 31, 981.
23. O. Ruff, and H. Goeres, Ber., 1910, 44, 502.
24. (a). Chen, P., Xiong, Z., Luo, J., Lin, J., Tan, K. L., Nature, 2002, 420, 302; (b). Chen, P., Xiong, Z., Luo, J., Lin, J., Tan, K. L., J. Phys. Chem. B 2003, 107, 10967; (c). Xiong, Z., Wu, G., Hu, J., Chen, P., Adv. Mater. 2004, 16, 1522.
25. (a). Hu, Y.H., Ruckenstein, E., Ind. Eng. Chem. Res. 2003, 42, 5135; (b).Hu, Y.H., Ruckenstein, E., J. Phys. Chem. A 2003,107, 9737; (c).Hu, Y.H., Ruckenstein, E., Ind. Eng. Chem. Res. 2004, 43, 2464; (d).Hu, Y.H., Ruckenstein, E., Ind. Eng. Chem. Res. 2005, 44, 1510.
26. (a). Ichikawa, T., Isobe, S., Hanada, N., Fujii, H., J. Alloys Comp. 2004, 365, 271; (b). Leng, H.Y., Ichikawa, T., Hino, S., Hanada, N., J. Phys. Chem. B. 2004, 108, 8763; (c). Ichikawa, T., Hanada, N., Isobe, S., Leng, H., Fujii, H., J. Phys. Chem. B. 2004, 108, 7887. (d). Hino, S., Ichikawa, T., Ogita, N., Udagawa, M., Fuji, H., Chem. Commun., 2005, 3038.
27. Kojima, Y., Kawai, Y., Chem. Commun., 2004, 2210.
28. Luo, W., J. Alloys Comp. 2004, 381, 284.
29. (a). Kojima, Y., Kawai, Y., J. Alloys Comp. 2004, 395, 236; (b). Noritake, T., Nozaki, H., Aoki, M., Towata, S., Kitahara, G., Nakamori, Y., Orimo, S., J. Alloys Comp. 2004, 393, 264.
30. Lide, D.R., CRC Handbook of Chemistry and Physics, Ed. 81^{st}, CRC Press, Boca Raton, London, New York, Washington D.C., 2000.
31. Levine, R., Femelius, W.C., Chem. Rev., 1954, 54, 449.
32. Pinkerton, F.E., J. Alloys Comp. 2005, 400, 76.
33. Hu, Y.H. and Ruckenstein, E., Ind. Eng. Chem. Res. 2006, 45, 182.

We claim:

1. A method for producing a high hydrogen storage capacity solid comprising Li₂NH said method comprising the step of:
(a) reacting Li₃N and LiNH₂ to form Li₂NH such that the formed Li₂NH has a reversible hydrogen capacity of at least 4.5 wt %.

2. A method as in claim 1 further comprising performing the reaction at a temperature of between and including 50° C. and 400° C.

3. A method as in claim 2 further comprising performing the reaction for at least 1 minute.

4. A method as in claim 3 further comprising performing the reaction for at least 10 minutes.

5. A method as in claim 4 further comprising forming said solid by mixing powdered Li₃N and powdered LiNH₂ in a mol % in the range of from 0.2 mol Li₃N per mole of LiNH₂ to 5 mol Li₃N per mole of LiNH₂.

6. A method as in claim 5 further comprising forming said solid by mixing powdered Li₃N and powdered LiNH₂ in a mol % ratio of 08:1.2.

7. A method as in claim 1 wherein the reaction is performed at a temperature of between and including 200° C. and 320° C.

8. A method as in claim 7 wherein the reaction is performed at a temperature of between and including 230° C. and 300° C.

9. A method as in claim 6 wherein the powdered Li₃N and powdered LiNH₂ comprise particles that are in the range of from 0.5 nm to 10 mm in diameter.

10. A method as in claim 1, wherein the reversible hydrogen capacity is at least 5.0 wt %.

11. A method as in claim 1, wherein the reversible hydrogen capacity is at least 5.5 wt %.

12. A method as in claim 1, wherein the reversible hydrogen capacity is at least 6.0 wt %.

13. A method as in claim 1, wherein the reversible hydrogen capacity is at least 6.5 wt %.

14. A method as in claim 1, wherein the reversible hydrogen capacity is at least 6.8 wt %.

15. A method of storing hydrogen wherein a high hydrogen storage capacity solid comprising Li₂NH is produced by reacting Li₃N and LiNH₂ such that said solid has a reversible hydrogen capacity of at least 4.5 wt %.

16. A method as in claim 15, wherein said reversible hydrogen capacity is at least 6.8 wt %.

17. A method as in claim 16 wherein the method further comprises the step of
(a) subjecting said hydrogen storage solid to at least one hydrogen adsorption-desorption cycle.

18. A method as in claim 16 wherein said hydrogen storage solid is subjected to 4 hydrogen adsorption-desorption cycles.

19. A method as in claim 16 wherein said hydrogen storage solid is subjected to 7 hydrogen adsorption-desorption cycles.

20. A high hydrogen storage capacity solid comprised of Li₂NH prepared by the method of claim 1, which is substantially free of Li₃N and LiNH₂.
